(19) United States
(12) Patent Application Publication
(10) Pub. No.: US 2007/0015451 A1
(43) Pub. Date: Jan. 18, 2007

(54) Automatic temperature control system for unattended motor vehicles occupied by young children or animals

(76) Inventor: William H. McGrath JR., Whiting, NJ (US)

Correspondence Address: Charles I. Brodsky, 2 Bucks Lane, Marlboro, NJ, 07746, US

(21) Appl. No.: 11/483,634

(22) Filed: Jul. 11, 2006

Related U.S. Application Data
(60) Provisional application No. 60/698,766, filed on Jul. 14, 2005.

(51) Int. Cl. B60H 1/00

(52) U.S. Cl. 454/75; 180/271; 340/425.5

(57) ABSTRACT

A temperature control system that automatically operates the cooling/heating ventilation system of a motor vehicle occupied by persons or animals when temperatures sensed therein go beyond predetermined threshold.

### CROSS-REFERENCE TO RELATED APPLICATIONS

A Provisional Patent Application covering the invention herein was filed Jul. 14, 2005 as Ser. No. 60/698,766.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not applicable

### BACKGROUND OF THE INVENTION

1. Field of the Invention

This invention relates to protection of occupants of unattended motor vehicles as temperatures within rise or fall beyond acceptable limits.

2. Description of the Related Art

As will be understood, in recent years there has been an alarming increase in the number of infants, young children and animals dying from heat exposure while occupying unattended motor vehicles. Criminally prosecuting those adults responsible for leaving these children or animals unattended has not proven to be an effective deterrent. Defending such prosecutions on the grounds that the vehicle was only left unattended for a few minutes has not been very persuasive to a jury or judge, and no matter how much “hand-wringing” there may be, the child or animal continues beyond resuscitation. State and Local Governments which enact legislation banning the practice of leaving such an occupied vehicle unattended serve to highlight the problem, yet the only response that seems to have been brought is the operator's lowering of the vehicle's windows somewhat so as to hopefully allow ambient cooler air to waft in when away.

In an attempt to deal with the dangerous situations that such heat exposure could bring to the young child or animal occupant, many shopping centers and indoor malls have taken to the practice of having security patrols just drive around their parking lots and garages in an attempt to detect such conditions before yielding to disastrous results, and to somehow locate the vehicle owning shopper. The security and police patrols generally leaving of informational pamphlets under a shopper's windshield wipers as to the consequences of a temperature increase in closed vehicles is somewhat helpful, as is the reporting to store personnel by other shoppers of their seeing a young child or animal left within a parked vehicle.

Nevertheless, and unfortunately so, many of these young children and animals continue to die each year from heat exposure because of human error, mistake, accident and momentary forgetfulness when leaving the vehicle unattended to carry out some minor chore or task.

### SUMMARY OF THE INVENTION

As will become clear from the following description, the present invention recognizes this type of human error—no matter how innocent or accidental it may be—but acts to eliminate it from producing the heart-wrenching calamity which might inevitably follow. As will be seen, the invention describes an automatic temperature control system for these unattended vehicles for activation when a vehicle's occupant is unable by himself/herself or itself to take corrective action.

In accordance with the invention, an auxiliary motor is employed as part of a supplemental cooling system where temperatures increasingly rise to dangerous levels in the closed vehicles, or an auxiliary heating system for use where the internal temperatures fall to dangerously low levels. An auxiliary battery is included to operate either or both auxiliary arrangements, powered by solar panels or strips built into the vehicle—as along either its front or rear dashboards, its windows, or its various panels.

Recognizing that an increased temperature generally lowers as the hours advance during the day, and that a decreased temperature in colder climates tends to rise with time during the night, the solar energization and the battery construction of the invention are selected such that the battery charge need only be sufficient to last some eight hours or so—before automatically recharging again with recurring sunlight. Obviously, within such time frame, the adult would generally be expected to return to the vehicle in any event—with the belief that recognizing the temperature conditions inside the closed vehicle would then lead to the manual temperature regulation of the air conditioning or heat otherwise controlled automatically by the invention. Thus, depending upon the parameters selected and designed, an automatic cooling of the inside could be had once a predetermined increased threshold temperature is reached; conversely, a controlled heating can be initiated once the inside temperature of the vehicle falls to a certain amount. Continued cooling, on the one hand, or heating, on the other hand, would then last and be powered by the solar panels continuously as long as there was sunlight. If sunlight is not sufficient, then the charged batteries would take over until sunlight returns to power the motor and then recharge the battery.

The present invention, furthermore, affords a manner of determining whether an infant, young child or animal is present within the vehicle left unattended. A first preferred way is to condition the energization of the auxiliary cooling or heating system through the use of detecting a closed seatbelt being worn. If the seatbelt is closed, apparently it is being worn by someone in the vehicle, who needs to then be protected should the internal temperatures of the vehicle rise or fall to these predetermined threshold. Effective in situations where an infant is in the vehicle (as where the seatbelt secures a child seat), or in the case of younger children strapped in who fall asleep, the invention also recognizes that certain older children are able to disconnect the seatbelt when the vehicle is not in motion and they are just sitting inside—and, certainly, most family pets are not seatbelted when being driven about. In these latter situations, the detection apparatus for actuating the cooling, or heating, auxiliary cycle is accomplished through a motion detector since, at some time or another, either the older child or animal is going to wake and stir or move about. Such motion detection then, again, triggers the corrective action automatically once the threshold temperature is reached.

Operating in these manners, therefore, obviates the possible problem with an alternative proposed solution of employing a “weight” type of sensor as a conditioning factor for the temperature control which, could become energized simply by the weight of one's briefcase being put on the seat, or a shopping bag filled with groceries, instead of by the weight of a child or animal on a seat.

### BRIEF DESCRIPTION OF THE DRAWING

These and other features of the present invention will be more clearly understood from a consideration of the following description, taken in connection with the single figure of the drawing, in which:

FIG. 1 illustrates a block diagram helpful in an understanding of the invention to effectuate this temperature control in an unattended motor vehicle.

### DETAILED DESCRIPTION OF THE INVENTION

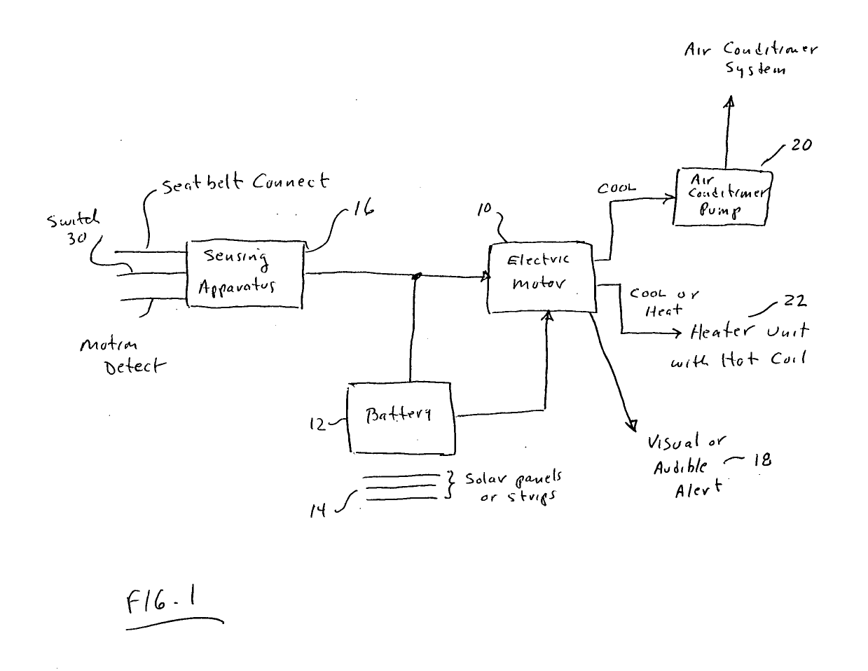

In FIG. 1, the separate electric motor (either for cooling the inside of the motor vehicle in hot weather or in heating the inside during cold weather) is shown at 10, with its separate, auxiliary battery 12 energized by one or more solar panels or strips 14 about the motor vehicle. The construction for the battery 12 may be such as to hold some eight hours of charge, sufficient to operate the motor 10, on the assumption that the human operator of the vehicle would return in that length of time, or in recognizing, for example, that by that time lapse, heated temperatures would tend to cool as the sun goes down or cold temperatures would tend to heat up as the sun rises.

Sensing apparatus is shown at 16 as being coupled with the battery 12 and the motor 10 to actuate the motor 10 once a threshold of temperature is reached upon command of a detector which senses the motion of an occupant in the vehicle (a child or animal), or one which senses a closed seatbelt connection for a young child or infant strapped in a seat. In accordance with the invention, the sensing apparatus 16 is one which can never be disabled; in this way, as long as the battery 12 is adequately energized, or there is sufficient sunlight, any motion or seatbelt connection sensed in the vehicle will actuate the motor 10 once the ambient conditions in the vehicle adjust to exceed the predetermined threshold—for example, 85°-90° F. for cooling, or 30-35° F. for heating. In other words, once the operator of the motor vehicle leaves, whether the ignition is turned OFF or ON, the sensing apparatus 16 will take over when the applicable threshold is reached, to automatically control the internal temperature of the vehicle within its cab compartment.

The present invention also recognizes that a further control could be implemented to appropriately and automatically “cool” or “heat” the vehicle when left unattended, even if the vehicle is left totally unoccupied; a manual switch 30 accomplishes this, activated by the vehicle's operator upon leaving. Such activation controls the sensing apparatus 16 to actuate the appropriate motor 10 whether or not a motion movement or seatbelt buckling-in connection is sensed. Shutting off this manual switch 30, however, has no effect upon the actuation of the motor 10 once either or both detectors come into play.

As will be apparent, while the invention as so far described operates to automatically protect the child or animal occupant in the presence of somewhat extreme temperature conditions, further protections can be implemented by having the sensing apparatus 16 also condition the motor 10 to provide various “alerts”—either visual or audible to “flash” or “sound”—as a further warning to those in the vicinity of the vehicle that a child or animal is at risk within the vehicle's confines. These visual and/or audible “alerts” are shown at 18 in FIG. 1.

Such apparatus, while particularly useful in taking away from the vehicle's operator the possibility of making a mistake when getting out of the vehicle, also affords a similar protection where the operator himself/herself may become disabled when still within the vehicle; although disabled inside, the motion detection sensor or the seatbelt connection sensor would continue to provide the benefits of keeping the temperature within controlled limits until an “alert” is observed, or someone comes upon the scene.

As will be appreciated, any electronic design for the sensing apparatus and for the controls of the motors employed could be had, and any appropriate design of the solar operated battery could follow. All that is required is a recognition that this degree of automatic control can be had based on a confluence recognizing the presence of some person or animal to be protected in the vehicle, and an exceeding of a predetermined temperature threshold, whatever it may be desired to be set at. So, for example, a similar motion detector could be installed in the trunk of the vehicle, along with a like ventilation system, auxiliary motor & battery, to automatically control the temperature there should a child, for example, accidentally become locked inside while playing.

And, as will be understood, while a human's forgetfulness when leaving the vehicle unattended may never be overcome, the mechanical nature of the invention's applicability will be seen to continue on unimpeded regardless.

(One further feature of the invention will also be appreciated in that the separate electric motor 10, once activated by the sensing apparatus 16, can be connected so as to controllably start the vehicle's own air conditioning or heating system as illustrated in FIG. 1, akin to a remote control type of starter. The air conditioner pump is shown at 20 for the cooling portion of the ventilation system, while the coil for the heating portion of the system is shown 22.)

While there have been described what are considered to be preferred embodiments of the present invention, it will be readily appreciated that modifications can be made by those skilled in the art without departing from the scope of the teachings herein. For at least such reason, therefore, resort should be had to the claims appended hereto for a true understanding of the scope of the invention.

I claim:

1. An automatic temperature controller for a closed, unattended motor vehicle equipped with a starting battery, a drive motor and an cooling/heating ventilation system, comprising:
an auxiliary solar powered motor with battery backup;
an auxiliary electric motor having a first input coupled to said solar powered motor with battery backup and a first output coupled to said cooling/heating ventilation system;
first means within said closed, unattended motor vehicle for sensing the temperature therein and for comparing it against a predetermined threshold; and
second means within said closed, unattended motor vehicle for sensing the presence of persons or animals therein;
with said auxiliary electric motor having a second input coupled to said second means for actuation thereby to operate said cooling/heating ventilation system upon sensing the presence of a person or animal within the closed, unattended motor vehicle and the sensing of a temperature therein beyond said predetermined threshold.

2. The automatic temperature controller of claim 1 wherein said auxiliary motor and battery is solar powered by individual ones of panels and strips built into at least one of dashboards, windows, roofs and panels of said motor vehicle.

3. The automatic temperature controller of claim 2 wherein said auxiliary motor is solar powered and backup battery are solar charged for substantially 8 hours.

4. The automatic temperature controller of claim 1 wherein said auxiliary battery, auxiliary electric motor and said first and second means are included in a cab compartment of said closed, unattended motor vehicle.

5. The automatic temperature controller of claim 1 wherein said auxiliary electric motor includes a second output to provide one of a visual and audible alert upon the sensing of a person or animal within said closed, unattended motor vehicle of a temperature beyond said threshold.

6. The automatic temperature controller of claim 1 wherein said first means compares the temperature sensed within said closed, unattended motor vehicle against said predetermined threshold for operating a cooling-cycle of said cooling/heating ventilation system when said temperature exceeds said threshold.

7. The automatic temperature controller of claim 1 wherein said first means compares the temperature sensed within said closed, unattended motor vehicle against said predetermined threshold for operating a heating-cycle of said cooling/heating ventilation system when said temperature falls below said threshold.

8. The automatic temperature controller of claim 1 wherein said first means compares the temperature sensed within said closed, unattended motor vehicle against said predetermined threshold for operating a cooling-cycle of said cooling/heating ventilation system when said temperature exceeds said threshold, and wherein said first means compares the temperature sensed within said closed, unattended motor vehicle against said predetermined threshold for operating a heating-cycle of said cooling/heating ventilation system when said temperature falls below said threshold.

9. The automatic temperature controller of claim 8 wherein said first means actuates said cooling-cycle of said cooling/heating ventilation system when the sensed temperature exceeds 80° F., and actuates said heating-cycle of said cooling/heating ventilation system when the sensed temperature falls below 35° F.

10. The automatic temperature controller of claim 8 wherein said second means is substantially always operationally enabled.

11. The automatic temperature controller of claim 8 wherein said second means includes a motion detector for sensing the movement of a person or animal within said closed, unattended motor vehicle.

12. The automatic temperature controller of claim 8 wherein said second means includes seat-belt closure detector apparatus for sensing the buckling-in of a person within the closed, unattended motor vehicle.

13. The automatic temperature controller of claim 8 wherein said second means includes a manually controllable switch operable from within said closed, unattended motor vehicle to identify the presence of a person within said motor vehicle.

14. The automatic temperature controller of claim 4, also including a first and second set of said first and second means, a second auxiliary solar powered battery and a second auxiliary electric motor within a trunk compartment of said closed, unattended motor vehicle along with a separated cooling/heating ventilation system therein coupled to an output of said second auxiliary electric motor to operate said second cooling/heating ventilation system upon sensing the presence of a person within such trunk compartment at a temperature beyond said predetermined threshold.

15. The automatic temperature controller of claim 14, wherein said second auxiliary electric motor includes a second output to provide one of a visual and audible alert upon the sensing of a person within said trunk compartment, when said temperature exceeds said predetermined threshold.
